(19) United States
(12) Patent Application Publication
(10) Pub. No.: US 2026/0199165 A1
(43) Pub. Date: Jul. 16, 2026

(54) THERAPEUTIC TABLE FOR POST-SURGERY PATIENTS

(71) Applicant: Carla Nohemi Delgado, Glenwood Springs, CO (US)

(72) Inventor: Carla Nohemi Delgado, Glenwood Springs, CO (US)

(21) Appl. No.: 19/021,463

(22) Filed: Jan. 15, 2025

(51) Int. Cl. A61G 13/12; A61G 13/00; A61G 13/10

(52) U.S. Cl. CPC A61G 13/1285; A61G 13/009; A61G 13/105; A61G 13/121; A61G 13/122; A61G 13/123; A61G 2200/325; A61G 2200/327

(57) ABSTRACT

A therapeutic table for a post-surgery patient. The therapeutic table includes a first base portion that at least partially defines an aperture. The therapeutic table includes a first lower cushioning layer that is coupled with the first base portion. The first lower cushioning layer at least partially defines the aperture. A post-surgery body part of the post-surgery patient extends into the aperture. The therapeutic table also includes a second base portion coupled with the first base portion. The therapeutic table further includes a second lower cushioning layer coupled with the second base portion.

### FIELD OF THE INVENTION

The present disclosure relates generally to therapeutic tables and, more particularly, to therapeutic tables for post-surgery patients.

### BACKGROUND OF THE INVENTION

Modern body manipulation practices such as chiropractic and massage aim to improve the health of patients. Therapeutic tables such as chiropractic tables and massage tables are built to support a body of the patient. Supporting the entire body is beneficial to allow an administrator of the therapy to easily reach and address specific body parts that the patient requires therapy on.

Patients who are recovering from surgery may not be able to endure laying on the therapeutic table. This can be for many reasons such as pressure loaded onto the post-surgery body part by the weight of the patient who is laying down. Consequently, the patient may delay seeking therapeutic treatment on their body. Further, delaying therapeutic treatment may prolong the healing process of the post-surgery body part.

Accordingly, an improved apparatus that allows therapeutic treatment to post-surgery patients would be desirable.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a

In another aspect, the present subject matter is directed to a

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of a post-surgery therapeutic table in accordance with aspects of the present subject matter;

FIG. 2 illustrates a plan view of the post-surgery therapeutic table in accordance with aspects of the present subject matter;

FIG. 3A illustrates a side sectional view of one embodiment of the post-surgery therapeutic table shown in FIG. 2 in accordance with aspects of the present subject matter;

FIG. 3B illustrates another side sectional view of another embodiment of the post-surgery therapeutic table shown in FIG. 2 in accordance with aspects of the present subject matter;

FIG. 4 illustrates a bottom perspective view of the post-surgery therapeutic table shown in FIG. 2 in accordance with aspects of the present subject matter;

FIG. 5 illustrates a perspective view of the post-surgery therapeutic table in a travel configuration in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

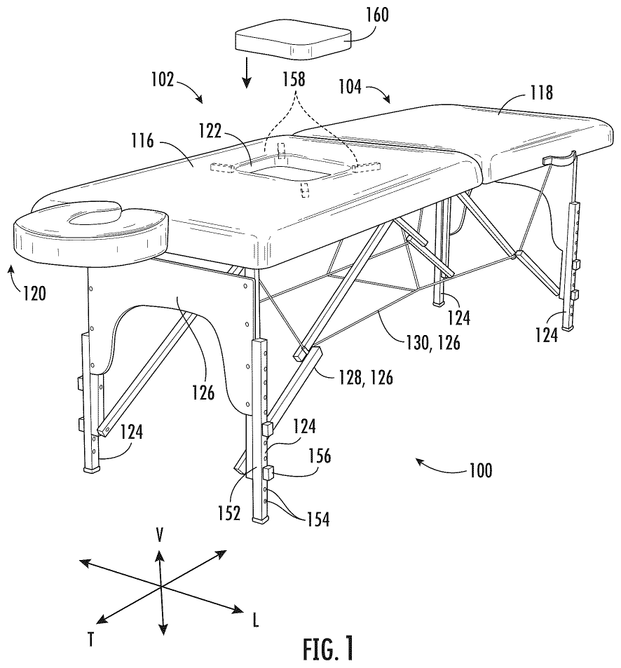

As used herein, the terms “first,” “second,” and “third” may be used interchangeably to distinguish one component from another and are not intended to signify location or importance of the individual components. Terms such as “inner” and “outer” refer to relative directions with respect to the interior and exterior of the post-surgery therapeutic table. For example, “inner” or “inward” refers to the direction towards the interior of the post-surgery therapeutic table. Terms such as “left,” “right,” “front,” “back,” “top,” or “bottom” are used with reference to the perspective of the therapeutic table as illustrated in FIG. 1. For example, a patient lays on top of the post-surgery therapeutic table to receive therapy with their head toward the front and their feet toward the back thereon.

As used herein, terms of approximation, such as “substantially,” “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

In general, the present subject matter is directed to a post-surgery therapeutic table. Specifically, the post-surgery therapeutic table defines an aperture configured to receive a post-surgery body part.

Referring now to the drawings, FIG. 1 illustrates a perspective view of one embodiment of a post-surgery therapeutic table 100 in accordance with aspects of the present subject matter. It should be appreciated that, although the post-surgery therapeutic table 100 illustrated herein corresponds to a chiropractic table or massage table, the post-surgery therapeutic table 100, or therapeutic table, may generally correspond to any suitable equipment or table configured to support a body of a patient seeking bodily manipulation therapy.

With reference to FIGS. 1 through 4, the transverse direction, denoted by the arrow labeled “T,” corresponds to the axis along which terms such as “front” and “back” are oriented. The vertical direction, indicated by the arrow labeled “V,” aligns with the axis associated with terms such as “top” and “bottom.” The lateral direction, represented by the arrow labeled “L,” defines the axis along which terms such as “left” and “right” are referenced. These directional conventions provide a standardized framework for the spatial orientation of the therapeutic table 100 described herein.

As shown in FIG. 1, the post-surgery therapeutic table 100 includes a first transverse assembly 102 and a second transverse assembly 104 transversely adjacent to the first transverse assembly 102. Additionally, or alternatively, the second transverse assembly 104 may abut the first transverse assembly 102. The therapeutic table 100 may also include a plurality of legs 124. As illustrated in the example embodiments of the figures, the therapeutic table 100 includes four legs 124. The legs 124 may be coupled with the first transverse assembly 102 and the second transverse assembly 104. For example, some, but not all, of the legs 124 may be coupled with and extend from a front end of the first transverse assembly 102. Additionally, or alternatively, some, but not all, of the legs 124 may be coupled with and extend from a back end of the second transverse assembly 104. Furthermore, the legs 124 may extend vertically downward from the first transverse assembly 102 and the second transverse assembly 104, respectively. Therefore, the therapeutic table 100 may be referred to as supported, and more specifically, supported vertically above a ground. The first transverse assembly 102 and the second transverse assembly 104 are described in more detail below.

The legs 124 may be adjustable such that a user of the therapeutic table 100 can adjust how far the therapeutic table 100 is supported above the ground. For example, the legs 124 may include sliding members 152 that define pin holes 154, where pins 156 can be inserted into respective pin holes of the sliding members to adjust a height of the legs 124. The legs 124 may also include a high friction bottom (not labeled) (e.g., rubber) to prevent the legs 124 from sliding along the ground. The legs 124 may be made from wood, a metal (e.g., aluminum), an alloy, or a polymeric material (e.g., HDPE). The sliding member 152 may be made of the same list of materials as the leg 124; however, the sliding member 152 may be made from a different material from the leg 124.

With continued reference to FIG. 1, the therapeutic table 100 may also include a reinforcement member 126 coupled with at least one of the legs 124, the first transverse assembly 102, or the second transverse assembly 104. Additionally, or alternatively, the therapeutic table 100 may include a plurality of reinforcement members 126, as illustrated in the example embodiments. The reinforcement member 126 may comprise a joist 128 coupled with at least one of the legs 124, the first transverse assembly 102, or the second transverse assembly 104. The joist 128 may couple with the leg 124 via a fastener extending through the leg 124 at a pin hole 154. Thus, the joist 128 may be rotatably coupled with the leg 124. Additionally, or alternatively, the joist 128 may be statically coupled with the leg 124 (e.g., via adhesive, fasteners, etc.). The joist 128 may be an elongate member. The joist 128 may be generally round or prismatic. Additionally, or alternatively, the joist 128 may be generally planar. For example, the joist 128 that is elongate may extend transversely, as illustrated in the example embodiments. Additionally, or alternatively, the joist 128 that is generally planar may extend over a lateral-vertical plane, as illustrated in the example embodiments. The joist 128 may be made of wood (as illustrated in the example embodiments), metal, alloy, or polymeric material.

The reinforcement member 126 may further include a cable 130 coupled with at least one of the legs 124, the first transverse assembly 102, the second transverse assembly 104, the joist 128, or the cable 130 itself. The cable 130 may extend transversely between joists 128, between the first transverse assembly 102 and the joist 128, between the leg 124 and the joist 128, or between the second transverse assembly 104 and the joist 128, as illustrated in the example embodiments. Additionally, or alternatively, the cable 130 may extend laterally between the cable 130 and the cable 130 itself, as illustrated in the example embodiments. Furthermore, the cable 130 may extend vertically between at least two of the leg 124, the first transverse assembly 102, the second transverse assembly 104, the joist 128, or the cable 130 itself. The cable 130 may couple with the leg 124, the first transverse assembly 102, the second transverse assembly 104, the joist 128, or the cable 130 itself via a fastener (as illustrated) or via any means one of ordinary skill in the art understands as being suitable for coupling the cable 130 to another member. The cable 130 may be made of a metallic braid, a metallic alloy braid, or a woven material (e.g., hemp, cotton, polyester, Nylon, etc.)

With even more reference to FIG. 1, the therapeutic table 100 may include a headrest 120 coupled with the first transverse assembly 102. Additionally, or alternatively, the reinforcement member 126 may be coupled with the first transverse assembly 102 and extend transversely therefrom. Further, the headrest 120 may couple with the reinforcement member 126 that transversely extends from the first transverse assembly 102. The headrest 120 may be generally Ω-shaped, as illustrated in the example embodiments of the figures.

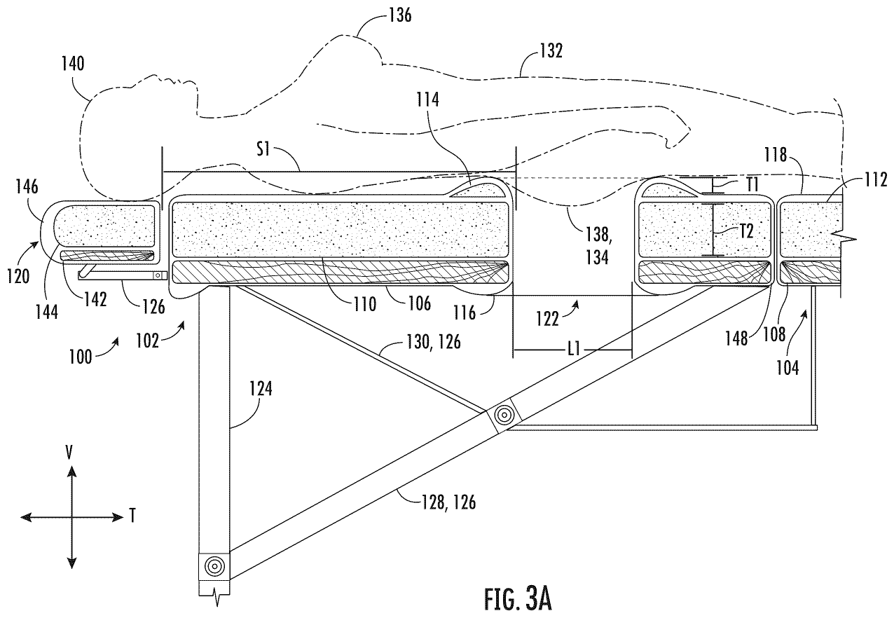

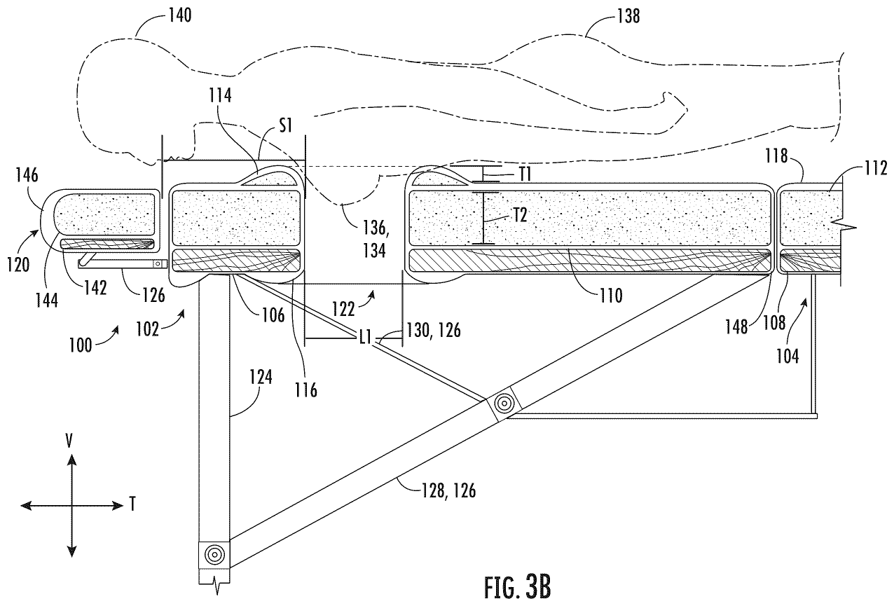

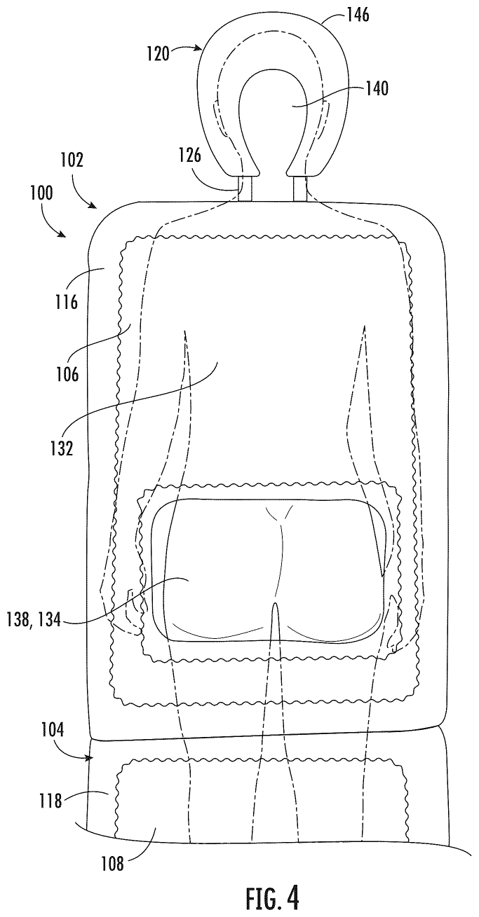

The first transverse assembly 102 defines an aperture 122 configured to receive a post-surgery body part 134 (FIGS. 3A through 4) of a patient 132 (FIGS. 3A through 4). The aperture 122 is described in greater detail below.

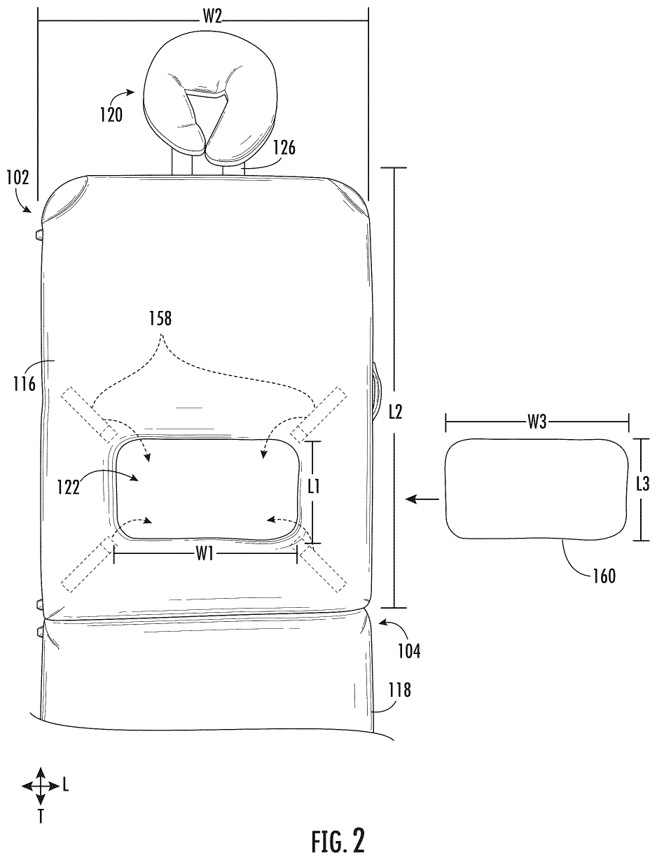

With reference to FIG. 2, the aperture 122 is defined by the first transverse assembly 102. The aperture 122 has a first lateral dimension W1, or first width. The first transverse assembly 102 has a second lateral dimension W2, or second width, that is larger than the first width W1. The first lateral dimension W1 is sized to laterally fit at least one of post-surgery breasts 136 (FIG. 3B) or post-surgery buttocks 138 (FIGS. 3A and 4). For example, the first lateral dimension W1 may be about 10 inches. Additionally, or alternatively, the first lateral dimension W1 may be about 20 inches. Additionally, or alternatively, the first lateral dimension W1 may be between about 11 inches and about 19 inches. Additionally, or alternatively, the aperture 122 may be laterally centrally defined by the first transverse assembly 102. For example, the first transverse assembly 102, including the aperture 122, may be symmetrical across a bisecting transverse plane that divides the first transverse assembly 102 into two equal lateral halves.

Additionally, or alternatively, the first aperture 122 has a first transverse dimension L1, or first length. The first transverse assembly 102 has a second transverse dimension L2, or second length, that is greater than the first length L1. The first transverse dimension L1 is sized to transversely fit at least one of post-surgery breasts 136 (FIG. 3B) or post-surgery buttocks 138 (FIGS. 3A and 4). For example, the first transverse dimension L1 may be about 8 inches. Additionally, or alternatively, the first transverse dimension L1 may be about 15 inches. Additionally, or alternatively, the first transverse dimension L1 may be between about 9 inches and about 14 inches.

The aperture 122 may be transversely asymmetrically defined by the first transverse assembly 102. For example, the first transverse assembly 102, including the aperture 122, may be asymmetrical across a bisecting lateral plane that divides the first transverse assembly 102 into two equal transverse halves. Further, the aperture 122 may be transversely defined distal from the headrest 120 or front end of the first transverse assembly 102 (as illustrated in FIG. 2), such that the aperture 122 is configured to receive post-surgery buttocks 138 (FIG. 3A) of the patient 132 (FIG. 3A). Additionally, or alternatively, the aperture 122 may be transversely defined proximate to the headrest 120 or front end of the first transverse assembly 102 (as illustrated in FIG. 3B), such that the aperture 122 is configured to receive post-surgery breasts 136 (FIG. 3B) of the patient 132 (FIG. 3B).

The first transverse dimension L1 and the first lateral dimension W1 may refer to dimensions of the aperture 122 that is generally rectangular, for example. The aperture 122 of the example embodiments in the figures is generally rectangular with rounded corners such that the first transverse dimension L1 is less than the first lateral dimension W1. Additionally, or alternatively, the first transverse dimension L1 and the first lateral dimension W1 may refer to a major dimension of extent and minor dimension of extent, respectively (e.g., an oval). The first transverse assembly 102 may define the aperture to be symmetrical in shape, as illustrated in the example embodiments. Additionally, or alternatively, the first transverse assembly 102 may define the aperture 122 to be asymmetrical in shape (e.g., an egg-shaped aperture).

The first transverse assembly 102 and the second transverse assembly 104 may be covered with a first cover layer 116 and a second cover layer 118, respectively. The first cover layer 116 and the second cover layer 118 may be made from the same material (e.g., leather, synthetic leather, cloth, etc.). The first cover layer 116 of the first transverse assembly 102 at least partially define the aperture 122. The first cover layer 116 and the second cover layer 118 may be formed to present a uniform layer without creases (e.g., wet forming, steam molding, boning, etc.). Additionally, or alternatively, the first cover layer 116 and the second cover layer 118 may be cut and sewn to fit over the first transverse assembly 102 and the second transverse assembly 104, respectively. Additionally, or alternatively, the first cover layer 116 and the second cover layer 118 may be cut (not shown) to fit over the first transverse assembly 102 and the second transverse assembly 104, respectively, and additional patches (not shown) may be coupled, via adhesives for example, with the first cover layer 116 and the second cover layer 118 to hide the cuts.

With reference to FIGS. 3A through 4, the therapeutic table 100 is configured to support the post-surgery patient 132, or patient. The therapeutic table 100 may be configured to support the patient 132 laying on their back (FIGS. 3A and 4). Additionally, or alternatively, the therapeutic table 100 may be configured to support the patient 132 laying on their stomach (FIG. 3B). The therapeutic table 100 is configured to support the patient 132 who has the post-surgery body part 134. The post-surgery body part 134 may be a side-by-side body part. For example, the post-surgery body part 134 may include buttocks, breasts, etc. The first transverse assembly 102 includes a first base portion 106 that may be specifically coupled with the legs 124 and the reinforcement members 126. The first base portion 106 of the first transverse assembly 102 at least partially defines the aperture 122. The first base portion 106 may be made of a rigid material (e.g., wood, metal, or a high-density polymeric material) to support the patient 132.

The first cover layer 116 is coupled with the first base portion 106. More specifically, the first cover layer 116 may be coupled with an underside of the first base portion 106 (e.g., via fasteners like staples, adhesives like glue, etc.). The first cover layer 116 may be coupled with the first base portion 106 proximate an outer edge of the first base portion 106. The first cover layer 116 may also be coupled with the first base portion 106 proximate a surrounding periphery of the aperture 122.

The first transverse assembly 102 includes a first lower cushioning layer 110, or lower cushioning layer, coupled with the first base portion 102. The first lower cushioning layer 110 may be coupled with the first base portion 102 via adhesives and/or fasteners. The first lower cushioning layer 110 may include at least one of a gel cushion, a foam cushion, an air cushion, a water cushion, or a pneumatic cushion. The first base portion 106 and the first lower cushioning layer 110 may extend laterally a distance about equal to the second lateral dimension W2. Therefore, the first base portion 106, the first lower cushioning layer 110, and the first transverse assembly 102 may have about equal widths. Additionally, or alternatively, the first base portion 106 and the first lower cushioning layer 110 may extend transversely a distance about equal to the second transverse dimension L2. Therefore, the first base portion 106, the first lower cushioning layer 110, and the first transverse assembly 102 may have about equal lengths. As illustrated in the example embodiments, the first transverse assembly 102 and the second transverse assembly 104 may have corners that are rounded. Additionally, or alternatively, the first transverse assembly 102 and the second transverse assembly 104 may have corners that are prismatic.

Similarly to the first transverse assembly 102, the second transverse assembly 104 includes a second base portion 108 that may be specifically coupled with the leg 124 and the reinforcement members 126. The second transverse assembly 104 may also include a second lower cushioning layer 112 coupled with the second base portion 104 via adhesives and/or fasteners. The second lower cushioning layer 112 may include at least one of a gel cushion, a foam cushion, an air cushion, a water cushion, or a pneumatic cushion. The second transverse assembly 104 is configured to support at least legs of the patient 132. The first lower cushioning layer 110 and the second lower cushioning layer 112 may be less rigid than the first base portion 106 and the second base portion 108, respectively, to provide more comfort to the patient 132.

The first transverse assembly 102 may also include an upper cushioning layer 114 coupled with the first lower cushioning layer 110. The upper cushioning layer 114 at least partially defines the aperture 122. Additionally, or alternatively, the upper cushioning layer 114 may circumscribe the aperture 122 vertically above the first lower cushioning layer 110. The upper cushioning layer 114 may have a first thickness T1 that tapers as the upper cushioning layer 114 extends away from the aperture 122. Referring again to the first lower cushioning layer 110, the first lower cushioning layer 110 may have a second thickness T2 that is greater than the first thickness T1, as illustrated. For example, the first thickness T1 may be about less than 20% of the second thickness T2. Additionally, or alternatively, the first thickness may be about less than 15% of the second thickness T2. Additionally, or alternatively, the first thickness T1 may be about 10% of the second thickness T2. Similar to the first lower cushioning layer 110, the upper cushioning layer 114 may include at least one of a gel cushion, a foam cushion, an air cushion, a water cushion, or a pneumatic cushion. The upper cushioning layer 114 may have a similar rigidity to the first lower cushioning layer 110. The first cover layer 116 covers the upper cushioning layer 114. Additionally, or alternatively, the first cover layer 116 and the first base portion 106 enclose the upper cushioning layer 114 and the first lower cushioning layer 110.

The upper cushioning layer 114 is configured to elevate the patient 132 around a post-surgery body part 134. Further, the upper cushioning layer 114 is configured to circumscribe the post-surgery body part 134. For example, the upper cushioning layer 114 may be configured to support a lower back (not labeled) and an upper thigh (not labeled) of the patient 132, as illustrated in FIG. 3A. Additionally, or alternatively, the upper cushioning layer 114 may be configured to support a collar region (not labeled) and a lower rib area (not labeled) of the patient 132, as illustrated in FIG. 3B. The upper cushioning layer 114 may assist in allowing the post-surgery body part 134 to extend into the aperture 122 to hang freely. Additionally, or alternatively, the legs 124 may also assist in allowing post-surgery body part 134 to extend into the aperture 122 to hang freely due to the first transverse assembly 102 being supported by the legs 124.

With specific reference to FIGS. 3A and 4, the aperture 122 may be defined by the first cover layer 116, the upper cushioning layer 114, the first lower cushioning layer 110, and the first base portion 106 distal the headrest 120. Space between the headrest 120 and the aperture 122 may be a first distance S1. The first distance S1 for the therapeutic table 100 that is configured to support the patient 132 having the post-surgery buttocks may be about 20 inches. Additionally, or alternatively, the first distance S1 for the therapeutic table 100 that is configured to support the patient 132 having the post-surgery buttocks may be about 26 inches. Additionally, or alternatively, the first distance S1 for the therapeutic table 100 that is configured to support the patient 132 having the post-surgery buttocks may be between about 21 inches and about 25 inches. Additionally, or alternatively, the therapeutic table 100 may be specifically designed and manufactured to have the first distance S1 be based on one patient 132 who is to use the therapeutic table 100.

With specific reference to FIG. 3B, the first distance S1 for the therapeutic table 100 that is configured to support the patient 132 having post-surgery breasts may be about 6 inches. Additionally, or alternatively, the first distance S1 for the therapeutic table 100 that is configured to support the patient 132 having the post-surgery breasts may be about 12 inches. Additionally, or alternatively, the first distance S1 for the therapeutic table 100 that is configured to support the patient 132 having the post-surgery breasts may be between about 7 inches and about 11 inches. Additionally, or alternatively, the therapeutic table 100 may be specifically designed and manufactured to have the first distance S1 be based on one patient 132 who is to use the therapeutic table 100.

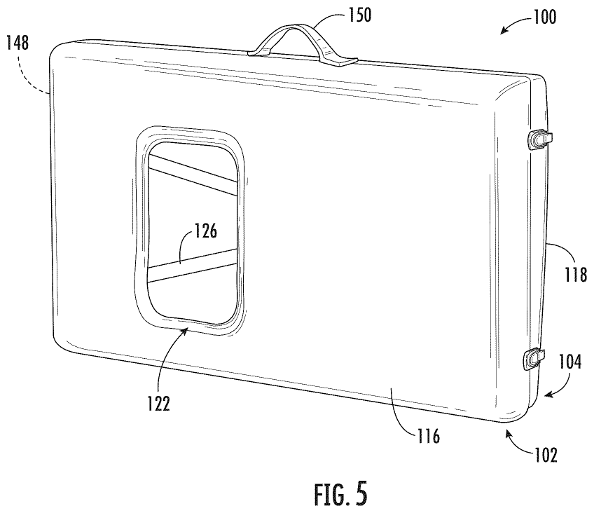

With reference to FIGS. 1 and 5, the therapeutic table 100 include a hinge 148 coupled between the first transverse assembly 102 and the second transverse assembly 104. The hinge 148 allows the therapeutic table 100 to fold, or transform, between a use configuration, as shown in FIG. 1, and a travel configuration, as shown in FIG. 4. The therapeutic table 100 may further include a handle 150 coupled with at least one of the first transverse assembly 102 or the second transverse assembly 104. The handle 150 may extend from the therapeutic table 100 such that a user can grab the handle to transport the therapeutic table 100 in the travel configuration. The legs 124 and the reinforcement members 126 may be folded when the therapeutic table 100 is in the travel configuration. The first transverse assembly 102 and the second transverse assembly 104 may cover the legs 124 and the reinforcement members 126 when in the travel configuration. Additionally, or alternatively, the legs 124 and/or the reinforcement members 126 (as illustrated) may be visible through the aperture 122 when the therapeutic table 100 is in the travel configuration. The therapeutic table 100 may also latch to retain the therapeutic table 100 in the travel configuration. For example, latches (not labeled) may be coupled with the first transverse assembly 102 and the second transverse assembly 104, where the latches couple in the travel configuration.

In another example embodiment, as illustrated in FIGS. 1 and 2, the therapeutic table 100 includes a removable insert 160. The removable insert 160 has a third transverse dimension L3, or third length. The third length L3 is about equal to the first transverse dimension L1. The removable insert 160 has a third lateral dimension W3, or third width. The third width W3 is about equal to the first lateral dimension W1. Therefore, the removable insert 160 that is selectively insert into the aperture 122 may be about flush with the first transverse assembly 102 such that there are minimal gaps between the removable insert 160 and the first transverse assembly 102 at the aperture 122. The removable insert 160 may include similar materials to the first transverse assembly 102. For example, the removable insert 160 may include a cover layer, a foam layer, and a wood layer (not shown).

According to the same example embodiment of FIGS. 1 and 2, the therapeutic table 100 may include prongs 158 moveably coupled with the first transverse assembly 102 at, for example, the base portion 106 (shown in FIG. 3A). The prongs 158 may be rotatably coupled with first transverse assembly 102 such that the prongs 158 rotate below the aperture 122. The prongs 158 rotated to beneath the aperture 122 are configured to support the removable insert 160 that is inserted into the aperture 122. The prongs 158 and the removable insert 160 may be configured to support the breasts 136 or the buttocks 138 of the patient 132. More specifically, the prongs 158 and the removable insert 160 may be configured to support the breasts 136 or the buttocks 138 of the patient 132 who can bare weight on said body parts.

Advantageously, the therapeutic table described herein allows a patient who has undergone surgery to also lay on the therapeutic table. For example, patients who have undergone cosmetic surgery (e.g., Brazilian butt lift, breast augmentation, etc.) can lay on the therapeutic table described herein without placing a weight of their body on the post-surgery body part. Avoiding such a load may allow the post-surgery body part to heal quicker. Further, the patient is able to experience therapy such as massage therapy and chiropractic therapy to also speed up healing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A therapeutic table for a post-surgery patient, the therapeutic table comprising:
a first base portion at least partially defining an aperture;
a first lower cushioning layer coupled with the first base portion, the first lower cushioning layer at least partially defining the aperture, wherein the aperture is configured to receive a post-surgery body part of the post-surgery patient;
an upper cushioning layer coupled with the first lower cushioning layer, wherein the upper cushioning layer has a first thickness that tapers as the upper cushioning layer extends away from the aperture;
a second base portion coupled with the first base portion; and
a second lower cushioning layer coupled with the second base portion.

2. The therapeutic table of claim 1, wherein the upper cushioning layer circumscribes a periphery of the aperture.

3. The therapeutic table of claim 2, further comprising a cover layer coupled with the first base portion, wherein the first lower cushioning layer and the upper cushioning layer are enclosed between the first base portion and the cover layer.

4. The therapeutic table of claim 2, wherein the upper cushioning layer has a first thickness, and wherein the first lower cushioning layer has a second thickness that is greater than the first thickness.

5. The therapeutic table of claim 1, wherein the aperture has a lateral dimension and a transverse dimension that is less than the lateral dimension.

6. The therapeutic table of claim 1, wherein the aperture is configured to receive side-by-side post-surgery body parts.

7. The therapeutic table of claim 1, further comprising a headrest coupled with the first base portion, wherein the headrest is configured to support a head of the post-surgery patient.

8. The therapeutic table of claim 7, wherein the aperture is spaced from the headrest such that post-surgery buttocks of the post-surgery patient are configured to extend into the aperture.

9. The therapeutic table of claim 7, wherein the aperture is spaced from the headrest such that post-surgery breasts of the post-surgery patient are configured to extend into the aperture.

10. The therapeutic table of claim 1, further comprising a plurality of legs coupled with the first base portion and the second base portion such that the first base portion and the second base portion are suspended, wherein the post-surgery body part extends into the aperture to hang freely.

11. The therapeutic table of claim 1, wherein the first base portion is hingedly coupled with the second base portion such that the therapeutic table folds between a use configuration and a travel configuration.

12. A first transverse assembly of a therapeutic table, the first transverse assembly comprising:
a first base portion at least partially defining an aperture;
a lower cushioning layer coupled with the first base portion, wherein the lower cushioning layer at least partially defines the aperture;
an upper cushioning layer coupled with the lower cushioning layer, wherein the upper cushioning layer circumferentially surrounds a periphery of the aperture;
wherein the aperture is configured to receive a post-surgery body part of a patient who lays on the therapeutic table, and wherein the upper cushioning layer is configured to elevate the patient around the post surgery body part.

13. The first transverse assembly of claim 12, wherein the aperture has a transverse dimension and a lateral dimension that is greater than the transverse dimension.

14. The first transverse assembly of claim 12, wherein the aperture is configured to receive side-by-side post-surgery body parts.

15. The first transverse assembly of claim 14 further comprising a headrest coupled with the first base portion, wherein the headrest is configured to support a head of the patient.

16. The first transverse assembly of claim 15, wherein the aperture is spaced from the headrest such that the aperture is configured to receive post-surgery buttocks of the patient.

17. The first transverse assembly of claim 15, wherein the aperture is spaced from the headrest such that the aperture is configured to receive post-surgery breasts of the patient.

18. The first transverse assembly of claim 12, wherein the first base portion hingedly couples with a second base portion of a second transverse assembly of the therapeutic table.

19. The first transverse assembly of claim 12, wherein the first base portion couples with a plurality of legs to suspend the first transverse assembly such that the post-surgery body part of the patient is configured to extend into the aperture to hang freely.

20. The first transverse assembly of claim 12 further comprising a cover layer coupled with the first base portion, wherein the lower cushioning layer and the upper cushioning layer are enclosed between the cover layer and the first base portion.
